(19) United States
(12) Patent Application Publication
(10) Pub. No.: US 2019/0039938 A1
(43) Pub. Date: Feb. 7, 2019

(54) METHODS AND APPARATUS FOR HEAT TRANSFER BY CONDUCTION MORE THAN CONVECTION

(71) Applicant: Corning Incorporated, Corning, NY (US)

(72) Inventors: Dana Craig Bookbinder, Corning, NY (US); Jeffrey John Domey, Elmira, NY (US); John Christopher Thomas, Elmira, NY (US); Kevin Lee Wasson, Elmira, NY (US)

(73) Assignee: Corning Incorporated, Corning, NY (US)

(21) Appl. No.: 16/073,888

(22) PCT Filed: Jan. 27, 2017
(86) PCT No.: PCT/US2017/015280

§ 371 Date: Jul. 30, 2018

Related U.S. Application Data
(60) Provisional application No. 62/288,566, filed on Jan. 29, 2016.

(51) Int. Cl. C03B 27/048; C03B 29/12; C03B 35/24; B65H 51/16

(52) U.S. Cl. CPC C03B 27/048; C03B 29/12; B65H 2406/12; C03B 35/24; B65H 51/16; C03B 35/246

(57) ABSTRACT

Method and apparatus are provided for the controlled transport of glass sheets (13) or glass ribbons (15) undergoing heating and/or cooling (e.g., thermal tempering) by conduction more than convection. The controlled transport is achieved by applying a gas-based force (17,19,21) to the glass sheet (13) or glass ribbon (15). The gas-based force (17,19,21) can move the glass sheet (13) or glass ribbon (15) in a desired direction and/or cause it to acquire a desired orientation. The gas-based force (17,19,21) can also cause the glass sheet (13) or glass ribbon (15) to retain a desired position and/or a desired orientation. The gas-based force (17,19,21) can be applied to the glass sheet (13) or glass ribbon (15) continuously or intermittently. Systems for transitioning a glass sheet (13) or a glass ribbon (15) between a heating zone (27) and a quench zone (31) are also discussed.

This application claims the benefit of priority under 35 U.S.C. § 119 of U.S. Provisional Application Ser. No. 62/288,566 filed on Jan. 29, 2016, the content of which is relied upon and incorporated herein by reference in its entirety.

This application is related to and hereby incorporates herein by reference in full the following applications: Provisional Application Ser. No. 62/288,851, filed on Jan. 29, 2016, U.S. application Ser. No. 14/814,232, filed on Jul. 30, 2015; U.S. application Ser. No. 14/814,181, filed on Jul. 30, 2015; U.S. application Ser. No. 14/814,274, filed on Jul. 30, 2015; U.S. application Ser. No. 14/814,293, filed on Jul. 30, 2015; U.S. application Ser. No. 14/814,303, filed on Jul. 30, 2015; U.S. application Ser. No. 14/814,363, filed on Jul. 30, 2015; U.S. application Ser. No. 14/814,319, filed on Jul. 30, 2015; U.S. application Ser. No. 14/814,335, filed on Jul. 30, 2015; U.S. Provisional Application No. 62/031,856, filed Jul. 31, 2014; U.S. Provisional Application No. 62/074,838, filed Nov. 4, 2014; U.S. Provisional Application No. 62/031,856, filed Apr. 14, 2015; U.S. application Ser. No. 14/814,232, filed Jul. 30, 2015; U.S. application Ser. No. 14/814,181, filed Jul. 30, 2015; U.S. application Ser. No. 14/814,274, filed Jul. 30, 2015; U.S. application Ser. No. 14/814,293, filed Jul. 30, 2015; U.S. application Ser. No. 14/814,303, filed Jul. 30, 2015; U.S. application Ser. No. 14/814,363, filed Jul. 30, 2015; U.S. application Ser. No. 14/814,319, filed Jul. 30, 2015; U.S. application Ser. No. 14/814,335, filed Jul. 30, 2015; U.S. Provisional Application No. 62/236,296, filed Oct. 2, 2015; U.S. Provisional Application No. 62/288,549, filed Jan. 29, 2016; U.S. Provisional Application No. 62/288,566, filed Jan. 29, 2016; U.S. Provisional Application No. 62/288,615, filed Jan. 29, 2016; U.S. Provisional Application No. 62/288,695, filed on Jan. 29, 2016; U.S. Provisional Application No. 62/288,755, filed on Jan. 29, 2016.

### FIELD

This disclosure relates to methods and apparatus for heat transfer to and/or from glass articles by conduction more than convection. In certain embodiments, the disclosure relates to heating and/or thermally tempering glass articles by conduction more than convection.

### BACKGROUND

Commonly-assigned U.S. patent application Ser. No. 14/814,232, which was filed on Jul. 30, 2015, and is entitled “Thermally Tempered Glass and Method and Apparatuses for Thermal Tempering of Glass” (Attorney Docket No. SP14-159T), discloses methods and apparatus for heating and/or thermally tempering glass articles more by conduction than by convection. U.S. patent application Ser. No. 14/814,232 will be referred to hereinafter as the “'232 application.” The contents of the '232 application are hereby incorporated herein by reference in their entirety.

The present disclosure provides methods and apparatus for the controlled transport of glass articles undergoing the heating and/or thermal tempering of the '232 application. In certain embodiments, the disclosure provides such controlled transport without mechanical contact with the glass article so as to avoid degradation of the surface properties of the article during the heating and/or thermal tempering.

### Definitions

The phrases “glass sheet(s)” and “glass ribbon(s)” are used broadly in the specification and in the claims and include sheet(s) and ribbon(s) that comprise one or more glasses and/or one or more glass-ceramics, as well as laminates or other composites that include one or more glass and/or one or more glass-ceramic components. The phrase “glass article(s)” is used to refer to glass sheet(s) and glass ribbon(s) collectively.

Heating or cooling (including thermally tempering) a glass article more by conduction than by convection shall mean heating or cooling under conditions which satisfy Equation (18) of the '232 application.

The word “move” includes both translation and rotation.

### SUMMARY

In accordance with an embodiment, a method is provided for heating or cooling (e.g., thermally tempering) a glass sheet (13) or a glass ribbon (15) by conduction more than convection, the glass sheet or the glass ribbon having opposing major surfaces (11), the method comprising:

(a) controlling the movement of the glass sheet (13) or the glass ribbon (15) while the glass sheet (13) or the glass ribbon (15) is in or is passing through a gap (23) in which pressure is applied to the opposing major surfaces (11) of the glass sheet (13) or the glass ribbon (15); and

(b) heating or cooling (e.g., thermally tempering) the glass sheet (13) or the glass ribbon (15) by conduction more than convection while it is in or is moving through the gap (23);

wherein step (a) comprises applying at least one gas-based force to the glass sheet (13) or the glass ribbon (15) which gas-based force has at least one component whose direction is parallel to a major surface (11) of the glass sheet (13) or the glass ribbon (15).

For example, as illustrated in FIG. 1, if major surface 11 of a glass sheet or a glass ribbon lies in or is parallel to the xy-plane of an xyz coordinate system, then the gas-based force will have at least one of an x-component (either positive or negative) and a y-component (either positive or negative) and may have both. The gas-based force may also have a z-component (either positive or negative).

Vector 17 in FIG. 1 illustrates the case where the gas-based force has an orientation with respect to major surface 11 such that the force has x and z components (see, for example, the embodiment of FIGS. 4-6), vector 19 illustrates the case where the gas-based force has only an x component (see, for example, the embodiment of FIGS. 13-15), and vector 21 illustrates the case where the gas-based force has only a y component (see, for example, the embodiments of FIGS. 7-9 and 10-12). Although not shown in FIG. 1, the gas-based force can also have: (i) only y and z components, (ii) only x and y components, or (iii) x, y, and z components. Although shown as applied to the upper surface of the glass article in FIG. 1, the gas-based force can be applied to the bottom surface, both the top and bottom surfaces, and/or to one or more edges of the glass article.

In certain embodiments, the gas-based force causes the glass sheet or the glass ribbon to move in a desired direction and/or to acquire a desired orientation, while in other embodiments, the gas-based force causes the glass sheet or the glass ribbon to retain a desired position and/or a desired orientation. The gas-based force can be applied to the glass sheet or the glass ribbon continuously or intermittently.

In certain embodiments, the gas-based force is applied by gas bearing outlets that are slanted, i.e., the outlets are at an angle relative to vertical. In other embodiments, the gas-based force is applied through one or more gas walls produced by a locally higher gas flow rate. The gas wall(s) can be arranged parallel to the direction of motion of the glass sheet or the glass ribbon (hereinafter referred to as longitudinal wall(s)) or can be transverse to the direction of motion (hereinafter referred to as transverse wall(s)). The glass wall(s) apply a reactive force (the gas-based force) to a glass sheet or a glass ribbon when the glass sheet or glass ribbon comes into contact with the flowing gas of the wall. The wall(s) can be used to align glass article(s) during treatment, to control their spacing, and/or to control their speed, including temporarily bringing one or more articles to rest.

In addition to the foregoing, embodiments are discussed in which: (1) a glass sheet or a glass ribbon is passed from a heating zone to a quench zone without the use of a transition zone, (2) a transition zone is used but is made short enough so that vertical support of the glass sheet or the glass ribbon while it is being passed through the transition zone is not required, (3) a transition zone is used which provides one-sided or two-sided vertical support to the glass sheet or the glass ribbon as it is being passed through the transition zone, and (4) a transition zone is used which provides vertical mechanical support to the glass sheet or the glass ribbon as it is being passed through the transition zone.

Apparatus for practicing the methods is also disclosed.

The reference numbers used above are only for the convenience of the reader and are not intended to and should not be interpreted as limiting the scope of the invention. More generally, it is to be understood that both the foregoing general description and the following detailed description are merely exemplary of the invention and are intended to provide an overview or framework for understanding the nature and character of the invention.

Additional features and advantages of the invention are set forth in the detailed description which follows, and in part will be readily apparent to those skilled in the art from that description or recognized by practicing the invention as exemplified by the description herein. The accompanying drawings are included to provide a further understanding of the invention, and are incorporated in and constitute a part of this specification. It is to be understood that the various features of the invention disclosed in this specification and in the drawings can be used individually and in any and all combinations.

### BRIEF DESCRIPTION OF THE DRAWINGS

FIG. 1 is a schematic diagram illustrating the application of gas-based forces to a glass sheet or glass ribbon (represented collectively by the reference number 9) where the force has at least one component parallel to major surface 11 of the sheet or ribbon.

FIG. 2 is a schematic drawing showing a side view of apparatus for heating, transitioning, and quenching glass sheets in accordance with an embodiment of the disclosure.

FIG. 3 is a schematic drawing showing a side view of apparatus for heating, transitioning, and quenching a glass ribbon in accordance with an embodiment of the disclosure.

FIGS. 4, 5, and 6 are schematic drawings showing apparatus for controlling movement of glass sheets using gas-based forces produced by slanted outlets of a gas bearing. FIG. 4 is a side cross-sectional view through the slanted outlets of the gas bearing, FIG. 5 is a top view, and FIG. 6 is a side cross-sectional view through vertical outlets of the gas bearing.

FIGS. 7, 8, and 9 are schematic drawings showing apparatus for controlling movement of glass sheets, e.g., alignment of glass sheets, using gas-based forces produced by longitudinal gas walls. FIG. 7 is a top view, FIG. 8 is a side cross-sectional view through vertical outlets of a gas bearing, and FIG. 9 is an end cross-sectional view through the longitudinal gas walls and the vertical outlets of the gas bearing.

FIGS. 10, 11, and 12 are schematic drawings showing apparatus for controlling movement of glass sheets, e.g., alignment of glass sheets, using gas-based forces produced by a side gas pressure system. FIG. 10 is a top view, FIG. 11 is a side cross-sectional view through vertical outlets of a gas bearing, and FIG. 12 is an end cross-sectional view through two opposing nozzles of the side gas pressure system and the vertical outlets of the gas bearing.

FIGS. 13, 14, and 15 are schematic drawings showing apparatus for controlling movement of glass sheets, e.g., spacing between glass sheets, using gas-based forces produced by transverse gas walls. FIG. 13 is a top view, FIG. 14 is a side cross-sectional view through the transverse gas walls and vertical outlets of a gas bearing, and FIG. 15 is an end cross-sectional view through the vertical outlets of the gas bearing.

FIG. 16 is a schematic drawing showing a side view of apparatus for heating, transitioning, and quenching glass sheets where the transition zone does not provide vertical support to the glass article.

FIGS. 17 and 18 are schematic drawings showing side views of apparatus for heating and quenching glass sheets without the use of a transition zone. FIG. 17 shows tapering of gap 23 in a heating zone, and FIG. 18 shows tapering of the gap in a quench zone.

FIG. 19 is a schematic drawing showing a side view of apparatus for heating, transitioning, and quenching glass sheets where the transition zone provides one-sided vertical support to the glass article.

FIG. 20 is a schematic drawing showing a side view of apparatus for heating, transitioning, and quenching glass sheets where the transition zone provides one-sided vertical support to the glass article by a burner/substrate combination.

FIG. 21 is a schematic drawing showing a side view of apparatus for heating, transitioning, and quenching glass sheets where the transition zone provides one-sided vertical support to the glass article by liquid metal or liquid salt overflowing a barrier.

FIG. 22 is a schematic drawing showing a side view of apparatus for heating, transitioning, and quenching glass sheets where the transition zone provides one-sided vertical support to the glass article by a mechanical support having a low thermal mass.

FIG. 23 is a schematic drawing showing a side view of apparatus for heating, transitioning, and quenching glass sheets where the transition zone provides two-sided vertical support to the glass article.

FIG. 24 is a schematic drawing showing a side view of apparatus for heating, transitioning, and quenching glass sheets in which the apparatus is at an angle with respect to horizontal.

The reference numbers used in the drawings, which are not to scale, refer to the following:
9 a glass sheet or a glass ribbon
11 a major surface of a glass sheet or a glass ribbon
13 a glass sheet
15 a glass ribbon
17 vector
19 vector
21 vector
23 gap
23a thicker gap
23b thinner gap
25 direction of motion of glass sheet or glass ribbon
27 heating zone
29 transition zone
31 quench zone
33 gas bearing
35 slanted outlet of gas bearing
37 vertical outlet of gas bearing
39 longitudinal gas wall
41 gas flow in longitudinal gas wall
43 side gas pressure system
45 side gas pressure nozzle
47 transverse gas wall
49 gas flow in transverse gas wall
51 nozzle of transverse gas wall
53 angle from horizontal
55 taper
57 one-sided support
59 burner
61 substrate
63 liquid metal or liquid salt
65 barrier
67 mechanical support
69 motion of mechanical support
71 top support of two-sided support
73 bottom support of two-sided support

### DETAILED DESCRIPTION

FIGS. 2 and 3 schematically illustrate embodiments of systems of the type disclosed in the '232 application for thermally tempering glass articles more by conduction than by convection. The systems manage the changes in temperature (ΔT) of the glass articles as a function of time (t) and the length (L), width (W), and thickness (H) of the article(s), i.e., ΔT=f(L, W, H, t). In general, the dimensions of the glass article do not substantially change during the process, i.e., the process does not involve forming or reforming the articles.

As shown in these figures, the systems can include a heating zone 27, a transition zone 29, and a quench zone 31, it being understood that the controlled transport methods and apparatus disclosed herein can be applied to all of the zones, only one of the zones, e.g., just the quench zone, or only two of the zones, e.g., just the heating and quench zones, as desired. Also, some embodiments may employ only one of the zones, e.g., only the heating zone if only heating is desired.

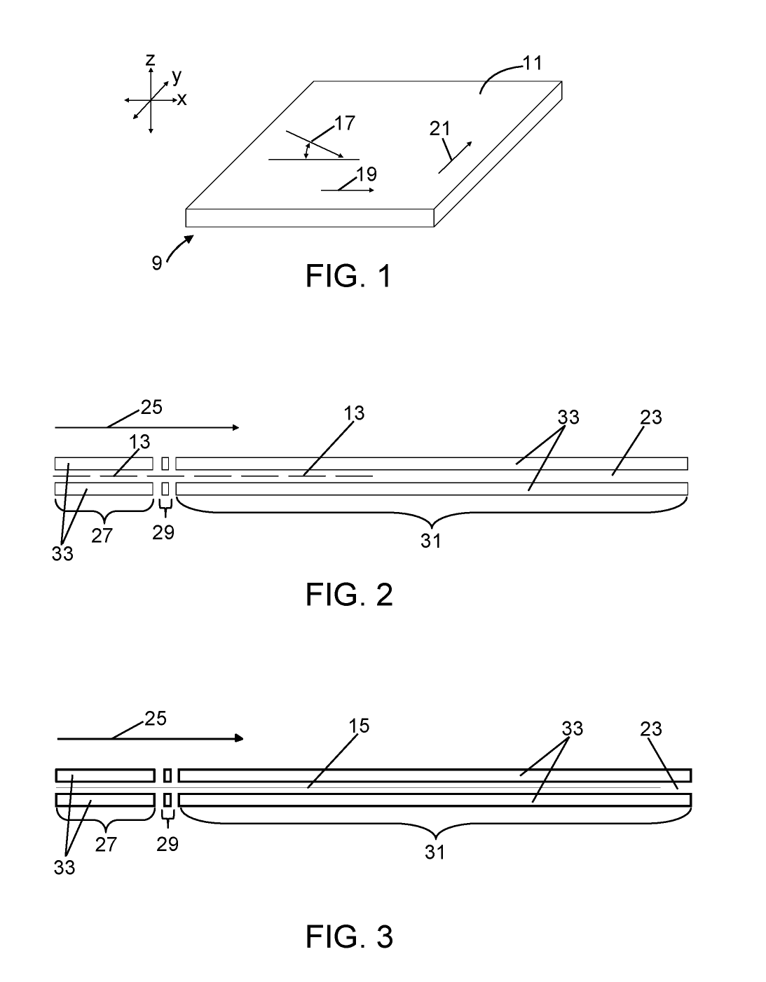

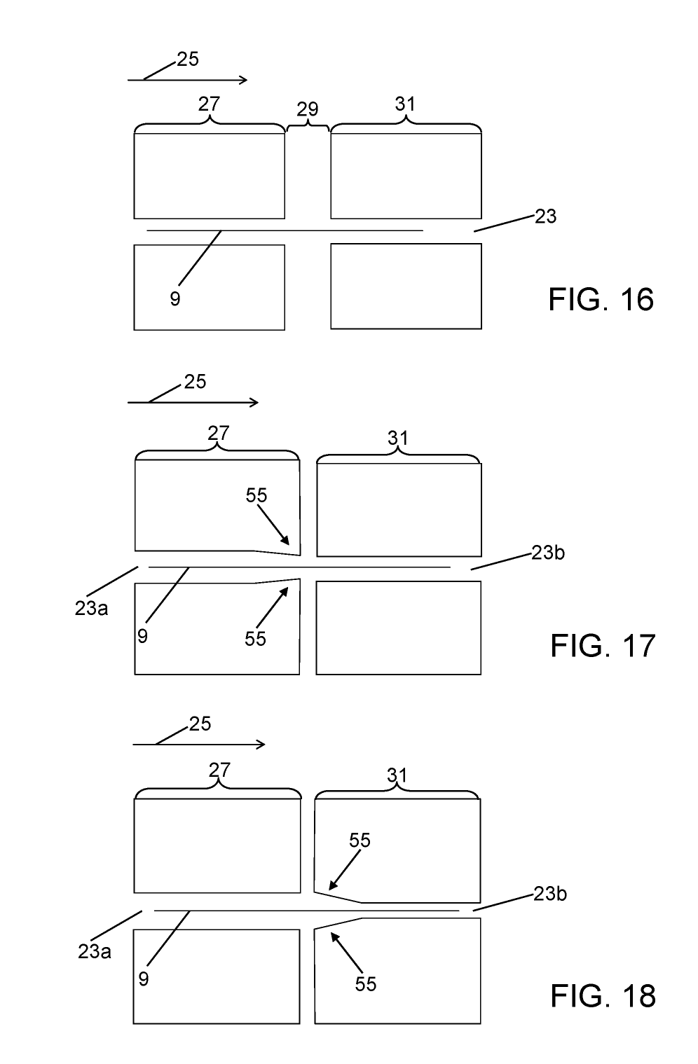

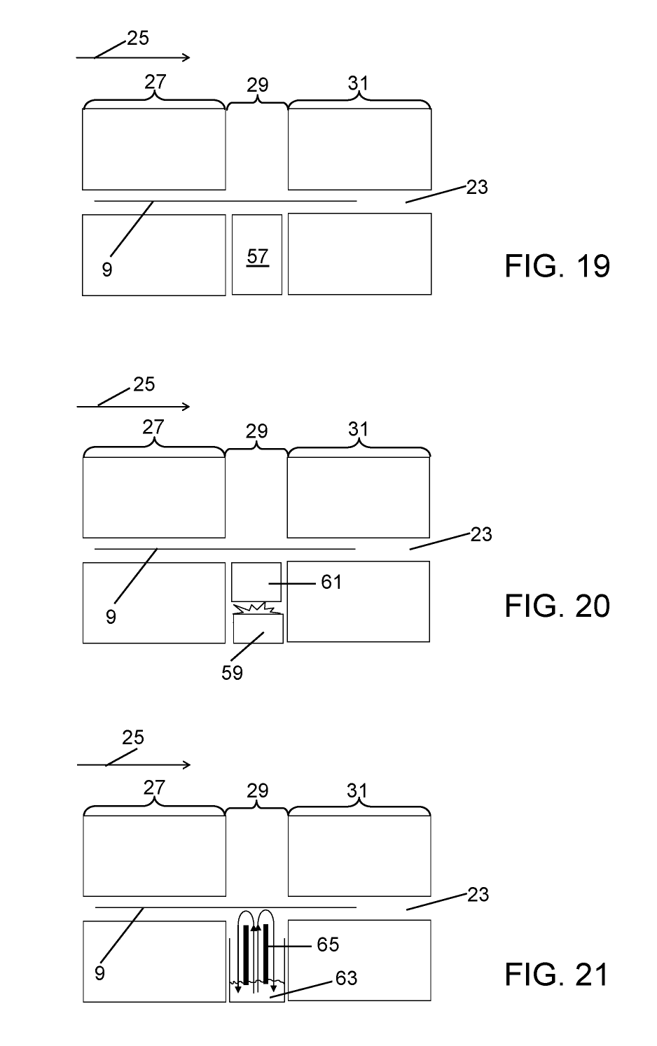

In general terms, heating zone 27 heats the glass article(s) to a temperature sufficient for thermal tempering, and quench zone 31 lowers the surface temperature of the article(s) at a rate sufficient to achieve a desired level of thermal tempering. As its name implies, transition zone 29 (when used) serves as an interface between the high temperatures of the heating zone and the low temperatures of the quench zone. As shown in FIGS. 1 and 2, heating zone 27 and quench zone 31 each includes gas bearing 33 for supporting the glass article(s) during heating and thermal tempering, respectively. The glass article(s) can be supported by a gas bearing in transition zone 29 or, as discussed below in connection with FIGS. 19-23, the glass article(s) can be supported in other ways or can be unsupported (FIG. 16). Also, as illustrated in FIGS. 17-18, the transition zone can be eliminated with the glass article(s) passing directly from the heating zone to the quench zone.

FIG. 2 illustrates a case where a series of glass sheets 13 are being thermally tempered, while FIG. 3 illustrates thermal tempering of a continuous glass ribbon 15. The glass sheets or the glass ribbon may be produced by, for example, a float process or a downdraw overflow fusion process. As indicated by arrow 25, the one or more glass articles pass through the zones from left to right in these figures. When individual articles are being treated, the speed of the articles can be the same in each of the zones or can be different, e.g., the speed through the heating zone can be faster, the same, or slower than the speed in the transition zone (when used) and/or the quench zone, or the speed in the transition zone (when used) can be faster, the same, or slower than the speed in the heating zone and/or the quench zone, or the speed in the quench zone can be faster, the same, or slower than the speed in the heating zone and/or the transition zone (when used). Moreover, the speed within any one zone need not be constant. For example, the article can become temporarily stationary in one or more of the zones.

When glass sheet(s) are being treated, the process can, for example, be characterized as a batch process, a semi-continuous process, or a continuous process. In a batch process, the glass sheet(s) can be moving at different speeds at different points in the process. For example, the glass sheet(s) can move through the heating zone at one speed or set of speeds, through the transition zone (when used) at another speed or set of speeds, and through the quench zone at still another speed or set of speeds. Likewise, for a semi-continuous process, the glass sheets can be moving at different speeds at different points in the process, with the spacings between glass sheets increasing and decreasing as the treatment takes place to avoid contact between the articles. As just one example, a given glass sheet can enter a zone and slow down or become stationary as a result of the application of a gas-based force, with the spacing to the next following glass sheet decreasing during the slow down or stationary period. The given glass sheet can then be accelerated by a gas-based force to restore the original spacing or some other spacing as appropriate.

For a glass ribbon, the process is continuous for any given ribbon. Nevertheless, the effects of different speeds can be achieved through adjustments in the lengths of the zones. Specifically, the effects of a higher speed can be achieved by a shorter zone (shorter residence time), and the effects of a slower speed by a longer zone (longer residence time). Such adjustments in the lengths of the zones can also be used with glass sheets if desired. Also, a combination of zone lengths and zone speeds can be used with glass sheets. In addition to speed considerations, zone lengths can change with the size of the glass sheets being processed, longer zones being used for longer glass sheets.

The temperature T of the glass article may be below, at, or above a desired T₀ when the glass article enters the heating zone. If below, the temperature is raised to T₀ or in some cases to T₀+ΔT to compensate for heat loss that may occur in the transition zone (when used). If the temperature of the glass article is already at T₀ at the start of the heating zone, then the heating zone can maintain that temperature or, alternatively, raise it to T₀+ΔT. If the temperature is already at T₀+ΔT, the heating zone can maintain that temperature. Alternatively, if the temperature of the article is already at T₀ (or, if desired, at T₀+ΔT), e.g., because it has been recently formed by, for example, a float or fusion process, the heating zone may be eliminated, with the article going directly to the transition zone (when used) or directly to the quench zone.

After leaving the heating zone (when used), the glass article can enter the transition zone (when used), which can serve to minimize adverse impacts to the glass article and/or the process as a result of the sharp change in temperature needed to achieve thermal tempering. The transition zone can also be used to change the thickness of gap 23 from that used in the heating zone to that used in the quench zone. For example, the gap may be thicker in the heating zone than in the quench zone. The transition zone can be used to provide a smooth transition between the gap dimensions.

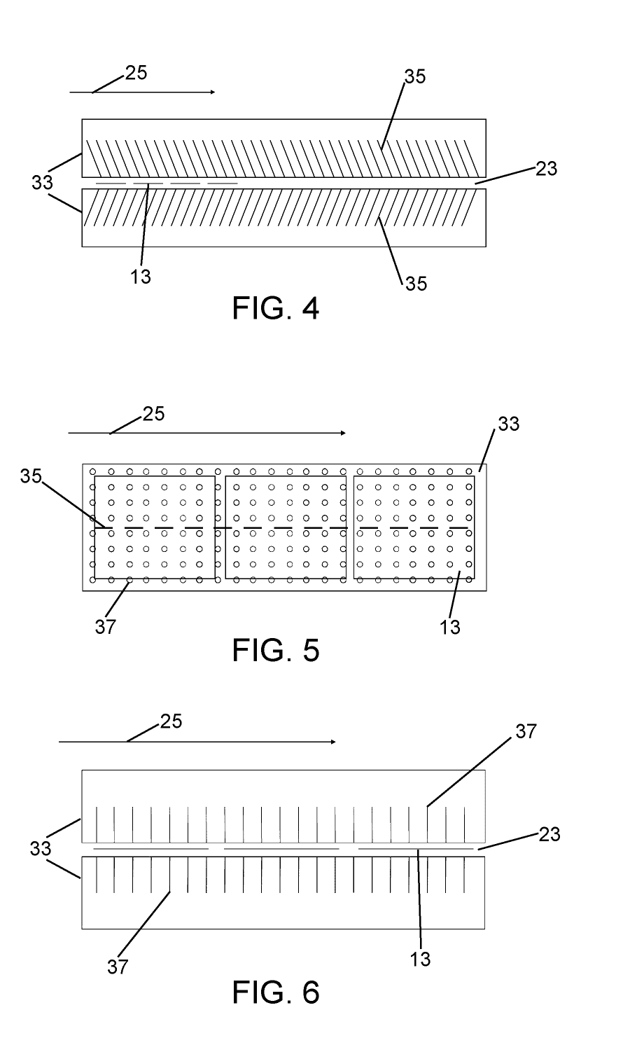

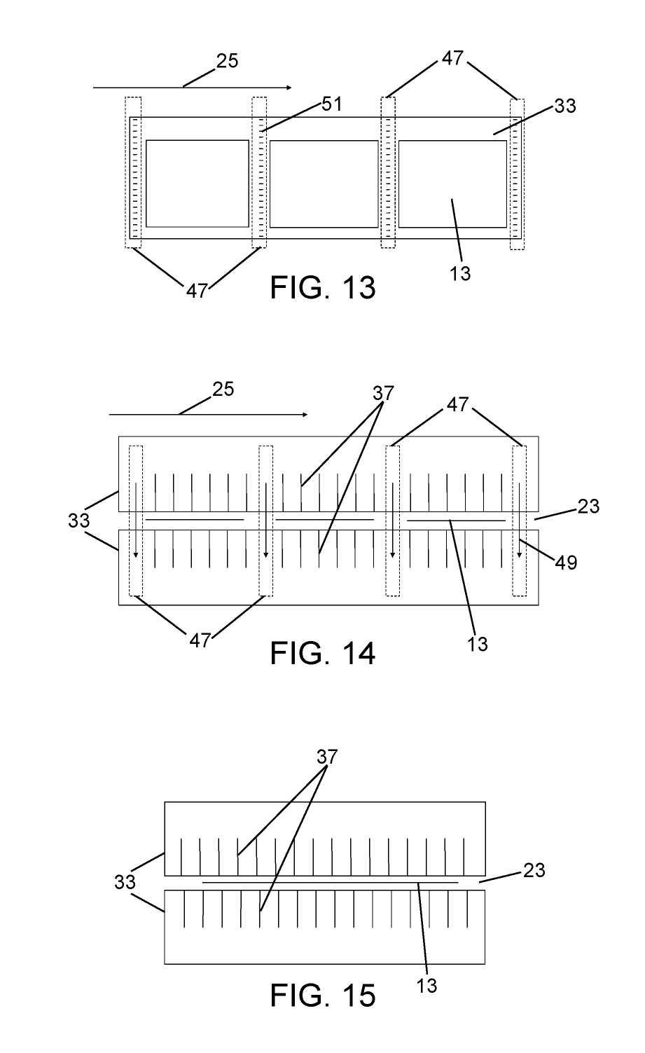

Depending on its length and construction, the transition zone can use a gas bearing of the type shown in FIGS. 4-15 and discussed below. Alternatively, the length of the transition zone can be minimized so that the glass article can pass through the zone unsupported. As known in the art, hot glass passing over rollers can develop a type of distortion known as “roller wave” distortion if the spacing between adjacent rollers is too large. The maximum allowable spacing depends on the thickness and viscosity (temperature) of the glass. Similarly, a transition zone in which glass article(s) are unsupported will have a maximum length depending on glass thickness and viscosity (temperature). As long as the transition zone length is below this maximum, glass article(s) can pass through the zone unsupported. FIG. 16 schematically illustrates a system with such a non-supporting transition zone.

If desired, the transition zone can in essence be eliminated with the glass article(s) passing directly from the heating zone to the quench zone. For example, the spacing between the heating zone and the quench zone can be less than about five times the thickness of the glass article. In connection with these embodiments, if the thickness of gap 23 is different in the heating and quench zones, the gap may be tapered (e.g., at a taper angle in the range of, for example, 0.001 to 90 degrees, with 90 degrees corresponding to a step change) in the region of the exit of the heating zone and/or in the region of the entrance to the quench zone. FIGS. 17 and 18 show an example of such tapering (see reference number 55) for the case where gap 23 is thicker in the heating zone than the quench zone. In particular, FIG. 17 shows tapering in the heating zone, and FIG. 18 shows tapering in the quench zone. Tapering in both zones can be used if desired. Reverse tapers will be used if the gap is thicker in the quench zone than the heating zone. Tapering in the heating and/or quench zones can also be used for embodiments which employ a transition zone.

If a transition zone is used and if vertical support in the transition zone is desired, the support can be either one-sided support where the supporting system acts from below the glass article or two-sided support where the supporting system acts both from above and from below the glass article. In either case, the magnitude of the upward force per unit area (upward pressure) needed to counteract the effect of gravity is small, as can be seen from the following calculation.

For a glass sheet having a density ρ, a thickness d, and major surfaces of area A, the weight (W) of the glass sheet is:

W=g*ρ*A*d,

where g is the gravitational constant (g=9.8 meters/second²). The weight per unit area (W/A) is then:

W/A=g*ρ*d.

Representative densities for glass sheets (and ribbons) are in the range of 2400-2800 kg/meter³, and representative thicknesses are in the range of 0.1-12 millimeters. Accordingly, the upward pressure needed to counteract the force of gravity in the transition zone are on the order of 2-300 Pascal (0.0003-0.04 psi).

FIGS. 19-22 illustrate representative one-sided support systems which can achieve these levels of pressure. The one-sided support 57 in FIG. 19 can, for example, be based on ultrasonic levitation (e.g., a frequency in the 5,000-200,000 hertz range and an amplitude in the 1-2,000 micron range), the Bernoulli principle including the Bernoulli principle as applied in a Bernoulli chuck, or simple gas pressure. For a system using the Bernoulli principle, one-sided support can also be from above the glass article, rather than from below. Compared to the heating zone where heat is added to the glass article and the quench zone where heat is removed from the glass article, relatively low levels of heat transfer take place in the transition zone. Accordingly, the support system used in that zone need not satisfy the more-heat-transfer-by-conduction-than-convection criterion which the quench zone satisfies and the heating zone will often satisfy. However, the transition zone can satisfy this criterion if desired.

FIGS. 20-22 illustrate other types of one-sided support systems that can be used to produce upward pressures sufficient to compensate for the effects of gravity. In FIG. 20, a burner 59 is arranged under a substrate 61, e.g., a ceramic honeycomb substrate. Hot exhaust gases from the burner pass through the substrate, which collimates the gas stream before it contacts the glass article. The hot gases both support the article and help control its temperature as it passes through the transition zone. FIG. 21 shows a support system based on liquid metal or liquid salt (see reference number 63) overflowing a barrier 65. The overflowing liquid metal or liquid salt provides both support and at least some temperature control for the glass article as it passes through the transition zone.

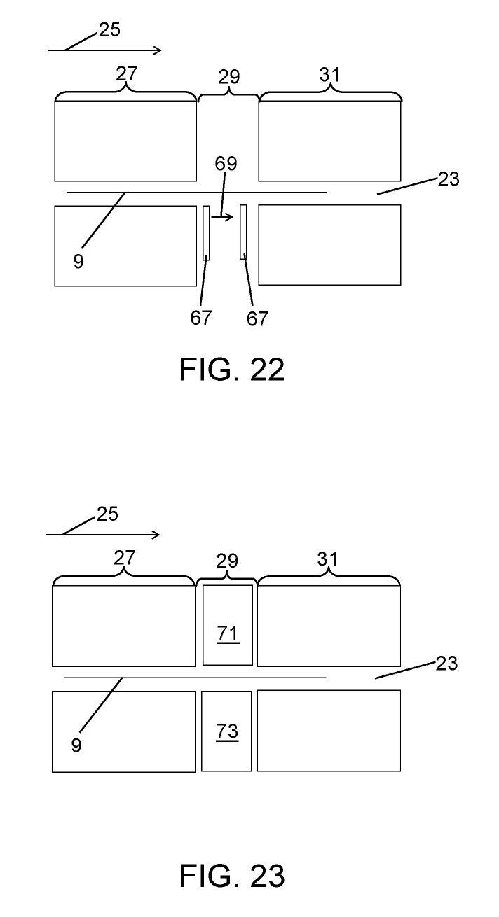

FIG. 22 shows a support system which uses one or more mechanical supports 67 having low thermal mass (low heat capacity). The support(s) may be stationary or can move with the glass article as illustrated schematically by arrow 69. The support(s) may also move vertically or from side-to-side. The support(s) can contact the glass article or can provide non-contact support by, for example, a gas cushion between the support and the surface of the article produced by flowing a gas over the top of the support(s).

Two-sided support can also be provided in a variety of ways. FIG. 23 shows the overall structure of a two-sided support system having a top support 71 and a bottom support 73. Compared to a one-sided system, a two-sided system has the advantage that it can be run in a differential mode with pressure being applied to the glass article from both sides, the pressure from below being greater than that from above so as to counteract the effect of gravity. Such differential mode operation helps with movement of the glass article, e.g., differential mode operation can provide self-centering of the article in the transition zone.

Many of the systems used for one-sided support can also be used for two-sided support, with a second copy of the system (either identical or modified) used for the top support. For example, two-sided systems can be based on ultrasonic levitation, the Bernoulli principle, simple gas pressure, or the burner/substrate system of FIG. 20. An electrostatic chuck with charged plates placed above and below the glass article can also be employed in a two-sided system. Combination systems can also be used. Although the primary purpose of the transition zone support system (when used) is to minimize sag in the vertical direction as the glass article passes through the transition zone, the support system, whether one-sided or two-sided, can also apply force to the glass article in the horizontal direction to, for example, control alignment and/or the spacing between sequential glass articles.

As noted above, the more-heat-transfer-by-conduction-than-convection criterion is satisfied in quench zone 31 and may be satisfied in heating zone 27 and/or transition zone 29. When this criterion is satisfied, the flow of gas into gap 23 from gas bearing 33 is low. Consequently, the glass article(s) are in a low friction environment when in gap 23 and thus their motion can be controlled with relatively small gas-based forces. The following calculations illustrate the low force magnitudes associated with such a low friction environment.

We consider two representative cases, a higher force case and a lower force case. The higher force calculation is for a higher mass glass sheet undergoing a larger change (increase or decrease) in speed over a shorter time period, and the lower force case is for a lower mass glass sheet undergoing a smaller change in speed over a longer time period. For the higher mass sheet, we consider a 3 meter by 3 meter sheet having a thickness of 12 millimeters and a density of 2800 kg/meter³, and for the lower mass glass sheet, we consider a 25 millimeter by 25 millimeter glass sheet having a thickness of 1 millimeter and a density of 2400 kg/meter³. The masses for these two cases are 302.4 kilograms and 0.0015 kilograms, respectively. For the larger change in speed over the shorter time period, we consider a speed change of 1 meter/second in 0.1 seconds, and for the smaller change in speed over the longer time period, we consider a speed change of 0.001 meters/second over 1 second. In each case, we assume that a constant force is applied over the time period.

From Newton's laws, we can write: FΔt=mΔv, where F is the gas-based force, Δt is the time over which the force acts, m is the mass of the glass sheet, and Δv is the change in speed. Evaluating this equation for the higher and lower force cases, we have forces of 3027 Newtons and 1.5×10⁻⁶ Newtons, respectively. Including friction in the calculation has a minimal effect on these values, the frictional force for the higher mass glass sheet being only 3.0 Newtons for a coefficient of friction of 0.001 (a high estimate), and is much lower for the lower mass glass sheet.

Assuming the gas-based force acts on an edge of the glass sheet, these forces for the higher and lower force cases correspond to pressures of 84.1 kilopascal (12.2 psi) and 0.06 Pascal (8.7×10⁻⁶ psi), respectively, which are readily achieved in practice. For a gas-based force applied to a major surface of a glass sheet, the angle at which the gas impacts the glass sheet comes into play, as well as the velocity of the gas leaving the outlets and the gas density. Computational fluid dynamics (CFD) can be used to calculate the tangential sheer force applied to the surface of the glass article for any particular arrangement of outlets and gap thicknesses and areas. For example, the commercially available ANSYS CFD software (ANSYS Inc., Canonsburg, Pa.) can be used for this purpose. In general terms, an individual outlet at an angle from horizontal in the range of approximately 30° can generate a tangential sheer force at least in the micro-Newton range for a flow velocity on the order of a few hundred meters/second. The number of outlets can then be adjusted to achieve the accelerations/decelerations of the glass article that are desired.

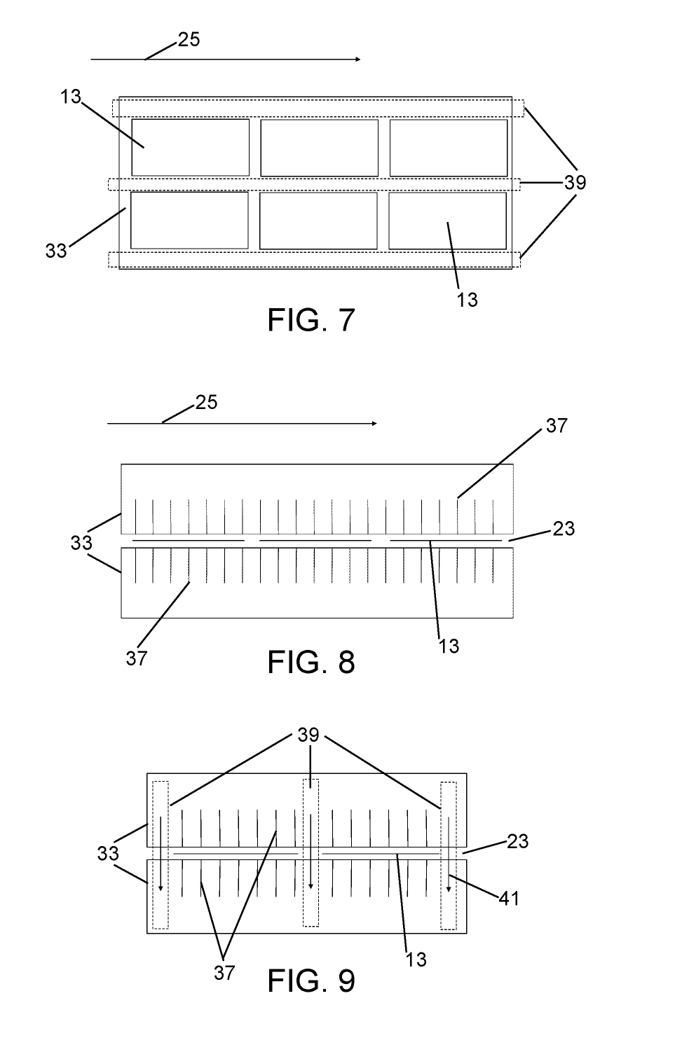

FIGS. 4-15 illustrate various ways in which gas-based forces can be applied to glass article(s). FIGS. 4-6 illustrate the use of slanted gas bearing outlets 35 formed in gas bearing 33 to apply gas-based forces (e.g., forces with a z-component and an x-component like force 17 in FIG. 1) to glass sheets 13 or to a glass ribbon (not shown in FIGS. 4-6). As shown in FIGS. 5 and 6, vertical gas bearing outlets 37 are also formed in gas bearing 33. These outlets serve to support and center the glass article(s) in gap 23 and, with outlets 35, provide the thin, low-flow gas layer (thin because gap 23 is thin and low-flow because the flow through outlets 35 and 37 is low) by which heat transfer by conduction more than by convection is achieved, as explained in the '232 application. As shown in FIGS. 8-9, 11-12, and 14-15, these vertical gas bearing outlets 37 are also used in the embodiments of FIGS. 7-9, 10-12, and 13-15 for the same purpose.

FIGS. 7-9 illustrate the use of longitudinal gas walls 39 to apply gas-based forces (e.g., forces with mainly a y-component like force 21 in FIG. 1) to glass sheets 13 or to a glass ribbon (not shown in FIG. 7-9). The walls are created by flowing gas 41 through vertical channels formed in gas bearing 33 at the locations where the walls are desired. As illustrated in FIGS. 7-9, the longitudinal gas walls can be used to maintain the left-right alignment of article(s) in or passing through gap 23. Although three walls are used in FIGS. 7-9, more or less walls can be used depending on the number of rows of glass article(s) being processed and whether alignment is needed from both sides of the article(s) or only one. For a glass ribbon, only two walls along the opposing edges of the ribbon are used or, in some applications, only one wall along one of the edges.

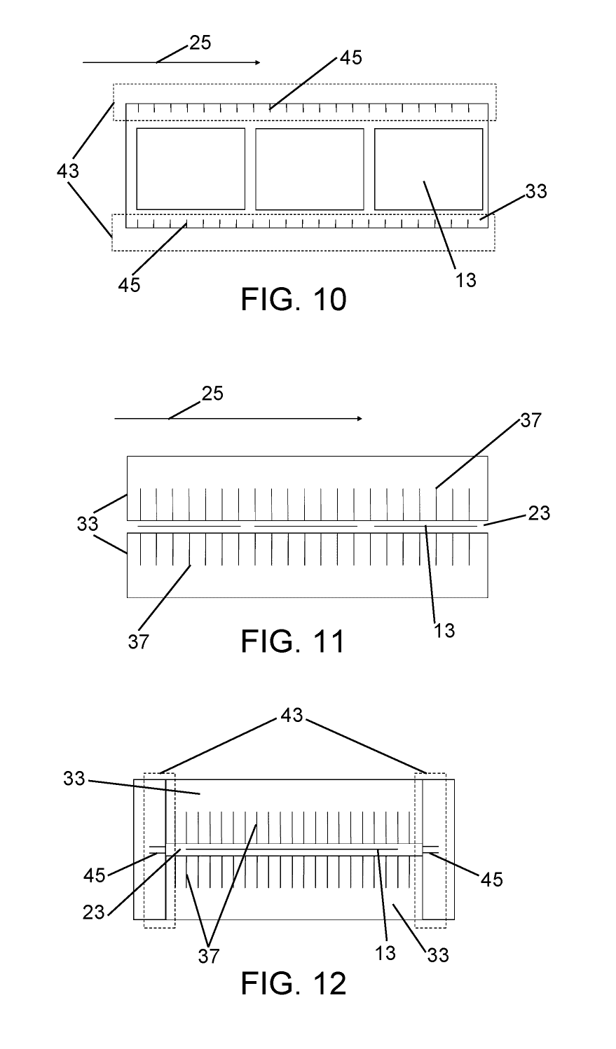

FIGS. 10-12 illustrate the use of a side pressure system 43 to apply gas-based forces (e.g., forces with mainly a y-component like force 21 in FIG. 1) to glass sheets 13 or to a glass ribbon (not shown in FIG. 10-12). As in the embodiment of FIGS. 7-9, the side pressure system can be used to maintain left-right alignment of article(s) in or passing through gap 23. For the side pressure system embodiment, the gas-based force is produced by passing gas transversely into gap 23 using nozzles 45. Although shown as acting on both sides of the glass article(s) in FIGS. 10-12, for some applications, a gas-based force may only be needed on one side. In such a case, only one set of nozzles 45 need be provided or if two are provided, only one need be activated. As noted above, the gas-based force can be intermittent and this can be beneficial in achieving left-right alignment, e.g., the locations of the article(s) can be sensed and gas-based, left-right alignment forces only applied when needed.

FIGS. 13-15 illustrate the use of transverse gas walls 47 to apply gas-based forces (e.g., forces with mainly an x-component like force 19 in FIG. 1) to glass sheets 13. The walls are created by flowing gas 49 from nozzles 51 through vertical channels formed in gas bearing 33 at the locations where the walls are desired. As illustrated in FIGS. 13-15, the transverse gas walls can be used to maintain front-back alignment of articles in or passing through gap 23, as well as the spacing between articles. Also, a transverse gas wall can be used to control the speed of a glass article passing through gap 23, including bringing the article to a stop if desired. The gas-based forces produced by the transverse gas walls will normally be applied intermittently with the gas flow typically being reduced (including being set to zero) while a glass article is moving past the location where the wall is located.

When a gas wall is used, whether it be a longitudinal or a transverse wall, at least some of the gas flowing from the vertical outlets 37 of gas bearing 33 (and the slanted outlets 35, when used) will enter the gas flow which forms the wall, rather than exiting from the sides of the gas bearing as occurs in the absence of a gas wall(s). The gas flow in a gas wall, whether a longitudinal or traverse wall, will generally be at least 2-3 times the gas flow from a vertical outlet 37, the amount of flow being dependent on the magnitude of the gas-based force needed to achieve motion control (e.g., steering) of the glass article(s) at the location of the wall.

The gas used in the above embodiments, as well as in other embodiments, can have a variety of compositions. The gas can be one gas or a mixture of gases from different gas sources or the same gas source. Exemplary gases include air, nitrogen, carbon dioxide, helium or other noble gases, hydrogen and combinations thereof.

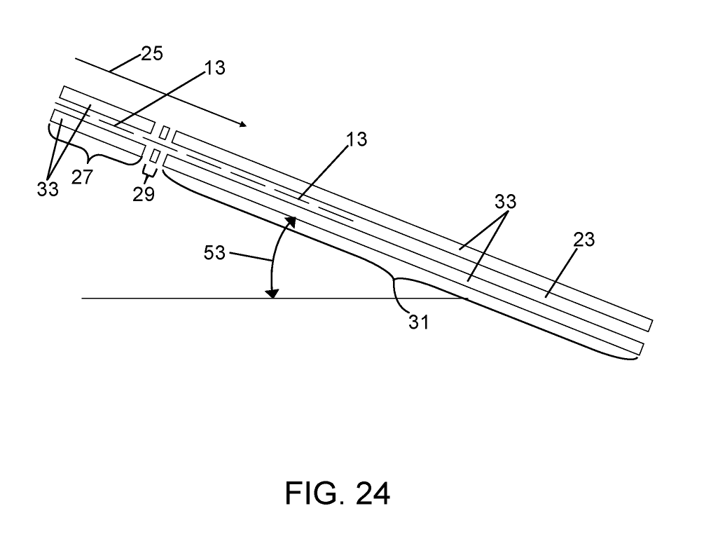

A variety of modifications that do not depart from the scope and spirit of the invention will be evident to persons having ordinary skill in the art from the foregoing disclosure. As just one example, as illustrated in FIG. 24, in addition to using gas-based forces to control the motion of glass article(s) when passing through a gap in which heat transfer takes place more by conduction than convection, the apparatus for practicing the disclosed methods, e.g., apparatus of the type shown generically in FIGS. 2 and 3, can be tilted relative to horizontal, e.g., by angle 53 in FIG. 24, so that gravity contributes to the motion of the glass article. Likewise, mechanical or other forces can be applied to the glass article(s) in addition to the gas-based force(s). Indeed, gravity, mechanical, or other forces alone can be used to move glass article(s) through the process, e.g., in connection with the systems discussed herein for transitioning a glass sheet or a glass ribbon between a heating zone and a quench zone.

What is claimed is:

1. A method for heating or cooling a glass sheet or a glass ribbon by conduction more than convection, the glass sheet or the glass ribbon having opposing major surfaces, the method comprising:
(a) controlling movement of the glass sheet or the glass ribbon while the glass sheet or the glass ribbon is in and/or is passing through a gap in which pressure is applied to the opposing major surfaces of the glass sheet or the glass ribbon; and
(b) heating or cooling the glass sheet or the glass ribbon by conduction more than convection while it is in and/or is moving through the gap;
wherein step (a) comprises applying at least one gas-based force to the glass sheet or the glass ribbon which gas-based force has at least one non-zero component whose direction is parallel to a major surface of the glass sheet or the glass ribbon.

2. The method of claim 1 wherein in step (b) the glass sheet or the glass ribbon is cooled and the cooling thermally tempers the glass sheet or the glass ribbon.

3. The method of claim 1 wherein the gas-based force causes the glass sheet or the glass ribbon to move in a desired direction and/or to acquire a desired orientation.

4. The method of claim 1 wherein the gas-based force causes the glass sheet or the glass ribbon to retain a desired position and/or a desired orientation.

5. The method of claim 1 wherein the gas-based force is applied to the glass sheet or the glass ribbon continuously.

6. The method of claim 1 wherein the gas-based force is applied to the glass sheet or the glass ribbon intermittently.

7. The method of claim 1 wherein the gas-based force is applied to the glass sheet or the glass ribbon by a gas bearing that comprises gas bearing outlets that are slanted.

8. The method of claim 7 wherein the gas bearing comprises gas bearing outlets that are vertical.

9. The method of claim 1 wherein the gas-based force is applied to the glass sheet or the glass ribbon by at least one gas wall.

10. The method of claim 9 wherein the gas wall is oriented parallel to the direction of motion of the glass sheet or the glass ribbon through the gap.

11. The method of claim 10 wherein the gas-based force provides left-right alignment for the glass article or the glass ribbon.

12. The method of claim 9 wherein a plurality of glass sheets are in or passing through the gap and the gas wall is oriented transversely to a direction of motion of the glass sheets.

13. The method of claim 12 wherein the gas-based force provides speed control for the plurality of glass sheets.

14. The method of claim 13 wherein the speed control comprises temporarily bringing one or more of the plurality of glass sheets to rest.

15. The method of claim 12 wherein the gas-based force provides inter-piece spacing control for the plurality of glass sheets.
